(19) United States
(12) Patent Application Publication
(10) Pub. No.: US 2021/0178812 A1
(43) Pub. Date: Jun. 17, 2021

(54) WHEEL HUB FOR MOUNTING A VEHICLE WHEEL

(71) Applicant: Schaeffler Technologies AG & Co. KG, Herzogenaurach (DE)

(72) Inventors: Paul Baerenstecher, Schweinfurt (DE); Jens Heim, Bergrheinfeld (DE)

(73) Assignee: Schaeffler Technologies AG & Co. KG, Herzogenaurach (DE)

(21) Appl. No.: 17/052,691

(22) PCT Filed: Apr. 30, 2019
(86) PCT No.: PCT/DE2019/100387

§ 371 Date: Nov. 3, 2020

(30) Foreign Application Priority Data
May 15, 2018 (DE) 10 2018 111 557.1
May 17, 2018 (DE) 10 2018 111 841.4

(51) Int. Cl. B60B 27/00; G01L 5/00; F16C 19/18

(52) U.S. Cl. CPC B60B 27/001; F16C 2326/02; F16C 19/183; G01L 5/0019

(57) ABSTRACT

A wheel hub permits mounting a vehicle wheel on a wheel axle. The wheel hub has a hub body and a roller bearing unit for mounting the hub body on an axle journal of the wheel axle, wherein the roller bearing unit has annular roller bearings for engaging the axle journal, each comprising an outer ring, an inner ring and a plurality of rolling elements. The wheel hub also includes at least one measurement ring arranged to be axially adjacent to at least one of the inner rings for engaging the axle journal, wherein the measurement ring includes at least one measurement setup for measuring strain and/or compression.

### CROSS-REFERENCE TO RELATED APPLICATIONS

This application is the U.S. National Phase of PCT Appln. No. PCT/DE2019/100387 filed Apr. 30, 2019, which claims priority to DE 10 2018 111 557.1 filed May 15, 2018 and DE 10 2018 111 841.4 filed May 17, 2018, the entire disclosures of which are incorporated by reference herein.

### TECHNICAL FIELD

The disclosure relates to a wheel hub for mounting a vehicle wheel on a wheel axle, having a hub body and a roller bearing unit for mounting the hub body on an axle journal of the wheel axle, wherein the roller bearing unit has annular roller bearings for engaging the axle journal, each of which has an outer ring, an inner ring, and a plurality of rolling elements.

### BACKGROUND

The publication DE 10 2014 200 714 A1 describes a wheel hub for commercial vehicles (referred to there as commercial motor vehicles).

Various systems for autonomous driving are currently being developed for commercial vehicles such as trucks, trailers and buses. Remote control sensors such as radar, laser, ultrasound, camera, etc. are used to control these systems. In this context, an even higher demand for additional sensor data can be expected in the future. The wheel forces are of particular interest, but vibration and temperature should also be measured.

### SUMMARY

It is desirable to provide a wheel hub which, with essentially the same structure, takes this increased need for sensor data into account.

A wheel hub for mounting a vehicle wheel on a wheel axle, includes a hub body and a roller bearing unit for mounting the hub body on an axle journal of the wheel axle, which has annular roller bearings for engaging the axle journal, which in turn each have an outer ring, an inner ring, and a plurality of rolling elements. The wheel hub also includes at least one measurement ring arranged to be axially adjacent to at least one of the inner rings for engaging around the axle journal, wherein this measurement ring has at least one measurement setup for measuring strain and/or compression. The measurement ring with the at least one measurement setup for strain and/or compression measurement is a type of sensor for determining wheel forces, which can be integrated particularly well into the wheel hub. The measurement ring makes it possible to measure the forces on the wheel bearing (contact forces, wheel and braking forces for disc brakes). Since the at least one measurement ring directly adjoins an inner ring of one of the roller bearings, the measurement ring can also be regarded as part of the roller bearing unit.

The measurement ring or at least one of the measurement rings may be arranged between the inner rings of the annular roller bearings. It connects directly axially to at least one of the inner rings.

Alternatively or additionally, the measurement ring or at least one of the measurement rings on a wheel side of the wheel hub may axially adjoin one of the inner rings. The wheel side is the side of the wheel hub on which the vehicle wheel can be mounted on the hub, and on which the vehicle wheel is essentially also located after installation.

Alternatively or additionally, the measurement ring or at least one of the measurement rings on a drive side of the wheel hub may axially adjoin one of the inner rings. The wheel side and the drive side are opposite sides of the wheel hub. The drive side of the wheel hub is the side from which the axle journal can be inserted into the wheel hub.

The measurement setup may also be a measurement setup for strain and/or compression measurement by means of strain gauges. Strain gauges are measurement devices for the detection of strain and compressive deformations. The electrical resistance thereof changes even with slight deformations and are used as strain sensors. As a rule, they are glued with special adhesive to components that deform minimally under load. This deformation (strain) then changes the resistance of the strain gauge.

The measurement setup may be a measurement setup for strain and/or compression measurement using Sensotect thin-film sensors, in which the functionality of the strain gauge is implemented as a direct coating on the respective component.

The measurement setup may be a measurement setup for measuring strain and/or compression using a magnetoelastic sensor.

The at least one measurement setup may be arranged on the surface, in particular the outer surface, of the measurement ring.

The at least one measurement setup may be arranged on or in an insert part integrated into the measurement ring.

A plurality of measurement setups may be provided, which are arranged on the measurement ring distributed over the circumference, in particular distributed uniformly over the circumference. In particular, four measurement setups are provided for measuring the strains at four widely distributed points (at 12 o'clock, 3 o'clock, 6 o'clock, 9 o'clock). Alternatively, two segments with corresponding measurement setups are provided.

The wheel hub, in particular the roller bearing unit of the wheel hub, may have a bushing for axially bracing the inner rings and the at least one measurement ring. The bushing is preferably arranged directly between the inner rings.

The annular roller bearings may be designed as tapered roller bearings. These are particularly suitable for constructing a wheel hub for commercial vehicles (commercial motor vehicles). The rolling elements of these tapered roller bearings are rollers in the form of a cone. The bearing unit is in particular an angular contact roller bearing.

A wheel hub as described above may be used for determining data about occurring wheel forces of a vehicle wheel during driving, in particular during autonomous driving, of the corresponding vehicle. This vehicle may be in particular a commercial vehicle (commercial motor vehicle), such as a trucks, trailer or bus.

### BRIEF DESCRIPTION OF THE DRAWINGS

In the following, the wheel hub is explained by way of example with reference to the attached drawings using preferred exemplary embodiments, the features shown below being able to represent various aspects both individually and in combination. In the figures:

FIG. 1: shows a wheel hub according to a first embodiment,

FIG. 2: shows a roller bearing unit of a wheel hub according to a second embodiment,

FIG. 3: shows a roller bearing unit of a wheel hub according to a third embodiment,

FIG. 4: shows a roller bearing unit of a wheel hub according to a fourth embodiment,

FIG. 5: shows two different arrangements of measurement setups on/in a measurement ring, and

FIG. 6: shows the structure of a measurement ring with ring segments.

### DETAILED DESCRIPTION

FIG. 1 shows the essential components of a wheel hub 10 for mounting a vehicle wheel on a wheel axle in half section (wheel and wheel axle not shown). The wheel hub 10 comprises a hub body 12, i.e., the actual hub, and a roller bearing unit 14 for mounting the hub body 12 on an axle journal (not shown) of the wheel axle, which is represented by the imaginary axis of rotation A. Only one part of the hub body 12 near the axle is shown in FIG. 1.

The roller bearing unit 14 is constructed as a double row angular contact roller bearing and comprises two roller bearings 16, 18, which in the example shown are designed as tapered roller bearings 20, 22 and are arranged in an O arrangement. Each of the roller bearings 16, 18 has an outer ring 24, a plurality of rolling elements 26 and an inner ring 28. The outer rings 24 of the roller bearings 16, 18 are fitted in the hub body 12 of the wheel hub 10. The rolling elements 26 used in a rolling element cage are guided on the outside on the respective outer ring 24 and on the inside on the respective inner ring 28 and can roll thereon. The rolling elements 26 are designed as tapered rollers. An axial end of the wheel hub 10 is a drive-side end and the corresponding side is the drive side 30 of the wheel hub 10. An axial end of the wheel hub 10 opposite the drive-side end is a wheel-side end and the corresponding side is the wheel side 32 of the wheel hub 10.

A measurement ring 34 is arranged axially adjacent to one of the inner rings 28. This measurement ring 34 forms a sensor for determining wheel forces via strain and compression measurements. In the example in FIG. 1, the measurement ring 34 on the drive side 30 of the wheel hub 10 connects axially to one of the inner rings 28 and forms the drive-side end of the wheel hub 10 at this radial height. The strain and compression measurements take place with regard to strains and compressions in the axial direction and/or radial direction and/or tangential direction and allow conclusions to be drawn about the corresponding axial, radial and tangential forces.

With installed tapered roller bearings 20, 22, the outer rings 24 are supported at a distance referred to as the collar width, positioned in relation to one another on a respective shoulder within the hub body 12. The axial bracing of the inner rings 28 (for example by means of an axle nut on the axle journal) results in a defined bearing play of the roller bearing unit 14. The wheel hub 10 can then be mounted on an axle journal (also known as a steering knuckle).

The wheel hub 10 is intended for use in trucks, trailers, buses and other commercial vehicles (commercial motor vehicles).

External forces on the wheel hubs 10 during operation of the corresponding vehicle, such as contact forces (axial forces Fa, radial forces Fr) and tangential forces (Ft) when accelerating or braking, cause strains on the inner rings 28 and on the mounted measurement rings 34.

Since the bearing is designed as a tapered roller bearing in an O arrangement, it must be braced axially, for example between an axle nut and the axle shoulder. The inner rings 28 can directly abut, as shown here in FIG. 1.

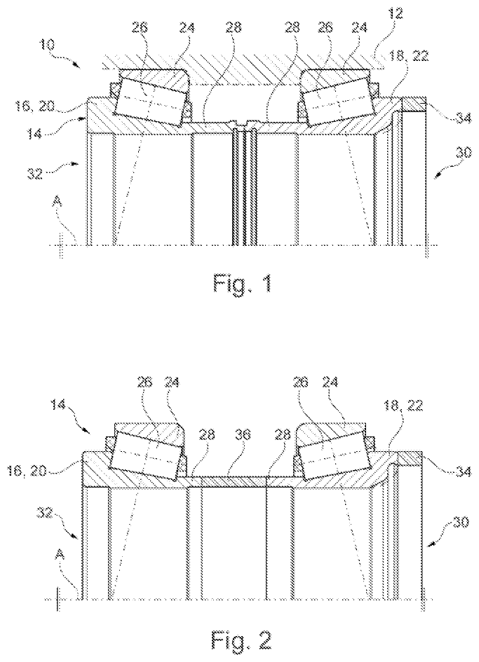

FIGS. 2 to 4 show design variants of the wheel hub 10. Since the corresponding wheel hubs 10 have essentially the same structure as the wheel hub 10 shown in FIG. 1, only the differences will be discussed here.

FIG. 2 shows a structure in which the measurement ring 34 is arranged between the axle journal and the inner ring 28 of the drive-side roller bearing 18, i.e., on the drive side 30. In this design variant, the inner rings 28 are braced via a bushing 36.

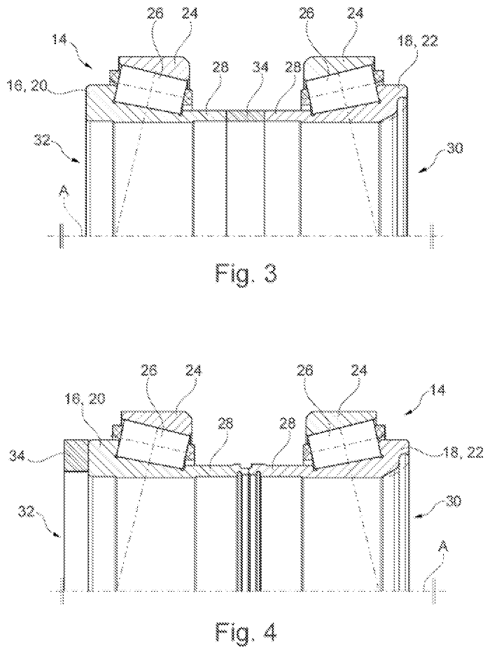

FIG. 3 shows a structure in which the measurement ring 34 is designed as a bushing and is arranged between the inner rings 28. In other words, the inner rings 28 are braced over the measurement ring 34 designed as a bushing.

FIG. 4 shows a structure in which the measurement ring 34 is arranged on the wheel side 32. In this design variant, the inner rings 28 abut directly, i.e., immediately.

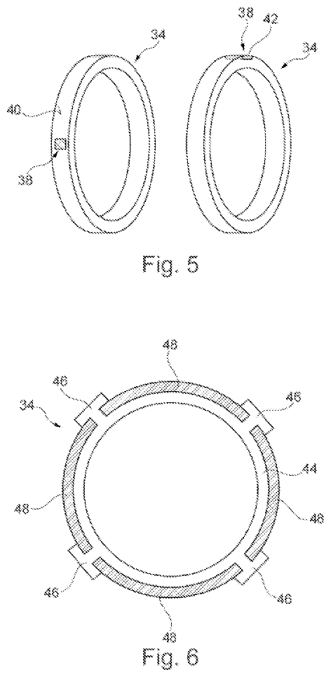

FIGS. 5 and 6 show details of the different embodiments of the measurement ring 34.

FIG. 5 shows two measurement rings 34. In the case of the left-hand measurement ring 34, the strains/compressions are measured directly on the surface 40 of the measurement ring 34 via a measurement setup 38. In the example, the measurement setup 38 is a setup with strain gauges or Sensotect sensors attached to the surface 40. In the case of the right-hand measurement ring 34, the strain is measured in/on additional elements 42 (only one of which is shown) which are introduced into the measurement ring 34.

FIG. 6 shows a measurement ring 34, which has a holding ring 44 as a base with four (n=4) circumferentially distributed holding elements 46, between which four (n=4) ring segments 48 are arranged on the outside of the measurement ring 34. The strains/compressions are measured on these ring segments 48.

The various embodiments may share some common features:

The strains/compressions are measured via strain gauges or corresponding sensors for strain measurement (e.g., from Sensotect) on an additional ring, the measurement ring 34. It is provided to measure the strains at n points (e.g., n=4 at 12 o'clock, 3 o'clock, 6 o'clock, 9 o'clock). Two bonded strain gauges or Sensotect strain gauges (one measures in the axial direction, the second in the tangential direction) are connected at each measuring point for temperature compensation. This is done in a half-bridge connection. Alternatively, the measuring points can also be differently interconnected (e.g., full bridge) and more or fewer measuring points could be provided (at least two for the separation of contact and tangential forces).

The measurement rings 34 are arranged on the wheel side 32, on the drive side 30, or between the inner rings 28.

The wheel forces are calculated from the measured strains/compressions.

### LIST OF REFERENCE SYMBOLS

10 Wheel hub
12 Hub body
14 Roller bearing unit
16 First roller bearing, annular
18 Second roller bearing, annular
20 First tapered roller bearing
22 Second tapered roller bearing
24 Outer ring
26 Rolling element
28 Inner ring
30 Drive side
32 Wheel side
34 Measurement ring
36 Bushing
38 Measurement setup
40 Surface
42 Insert part
44 Holding ring
46 Holding element
48 Ring segment

1. A wheel hub for mounting a vehicle wheel on a wheel axle, having a hub body and a roller bearing unit for mounting the hub body on an axle journal of the wheel axle, wherein the roller bearing unit has annular roller bearings for engaging the axle journal, each comprising an outer ring, an inner ring and a plurality of rolling elements,
further comprising at least one measurement ring arranged to be axially adjacent to at least one of the inner rings for engaging of the axle journal, wherein the measurement ring includes at least one measurement setup for measuring strain and/or compression.

2. The wheel hub according to claim 1, wherein the measurement ring is arranged between two inner rings of the annular roller bearings.

3. The wheel hub according to claim 1, wherein the measurement ring axially adjoins one of the inner rings on a wheel side of the hub.

4. The wheel hub according to claim 1, wherein the measurement ring axially adjoins one of the inner rings on a drive side of the wheel hub.

5. The wheel hub according to claim 1, wherein the measurement setup is a measurement setup for strain measurement by strain gauges.

6. The wheel hub according to claim 1, wherein the at least one measurement setup is arranged on an outer surface of the measurement ring.

7. The wheel hub according to claim 1, wherein the at least one measurement setup is arranged on or in an insert part integrated in the measurement ring.

8. The wheel hub according to claim 1, wherein the at least one measurement setup is a plurality of measurement setups which are arranged on the measurement ring distributed uniformly over a circumference.

9. The wheel hub according to claim 1, further comprising a bushing for axially bracing the inner rings and the at least one measurement ring.

10. The wheel hub according to claim 1, wherein the annular roller bearings are tapered roller bearings.

11. A wheel hub comprising:
a hub body;
a drive side outer ring and a wheel side outer ring, each fitted to the hub body;
a drive side inner ring;
a plurality of drive side rolling elements radially separating the drive side inner ring from the drive side outer ring;
a wheel side inner ring;
a plurality of wheel side rolling elements radially separating the wheel side inner ring from the wheel side outer ring; and
a measurement ring arranged to be axially adjacent to at least one of the drive side inner ring and the wheel side inner ring, wherein the measurement ring includes at least one measurement setup for measuring strain or compression.

12. The wheel hub according to claim 11, wherein the measurement ring is arranged between the drive side inner ring and the wheel side inner ring.

13. The wheel hub according to claim 11, wherein the measurement ring axially adjoins a side of the wheel side inner ring opposite the drive side inner ring.

14. The wheel hub according to claim 11, wherein the measurement ring axially adjoins a side of the drive side inner ring opposite the wheel side inner ring.

15. The wheel hub according to claim 11, wherein the measurement setup is a measurement setup for strain measurement by strain gauges.

16. The wheel hub according to claim 11, wherein the at least one measurement setup is arranged on an outer surface of the measurement ring.

17. The wheel hub according to claim 11, wherein the at least one measurement setup is arranged on or in an insert part integrated in the measurement ring.

18. The wheel hub according to claim 11, wherein the at least one measurement setup is a plurality of measurement setups which are arranged on the measurement ring distributed uniformly over a circumference.

19. The wheel hub according to claim 11, further comprising a bushing for axially bracing the drive side inner ring and the wheel side inner ring.
